(19) United States
(12) Patent Application Publication
(10) Pub. No.: US 2026/0329845 A1
(43) Pub. Date: Oct. 22, 2026

(54) HIGH PERFORMANCE DATA EXPORT

(71) Applicant: The PNC Financial Services Group, Inc., Pittsburgh, PA (US)

(72) Inventor: Jason L. Miller, Chandler, AZ (US)

(73) Assignee: The PNC Financial Services Group, Inc., Pittsburgh, PA (US)

(21) Appl. No.: 19/414,359

(22) Filed: Dec. 10, 2025

Related U.S. Application Data
(60) Provisional application No. 63/791,082, filed on Apr. 18, 2025.

(51) Int. Cl. G06F 16/23; G06F 16/215

(52) U.S. Cl. CPC G06F 16/2365; G06F 16/215

(57) ABSTRACT

Computer-implemented systems and methods merge data from a source view into an export table using a compound key to identify new, updated, or soft-deleted records. Flagged records are exported for downstream use, ensuring efficient synchronization and minimizing redundant processing, even with hundreds of thousands of continuously changing data records.

### PRIORITY CLAIM

The present application claims priority to U.S. Provisional Patent Application No. 63/791,082, filed Apr. 18, 2025, titled HIGH PERFORMANCE DATA EXPORT, which is incorporated by reference herein in its entirety.

### CROSS-REFERENCE TO RELATED APPLICATIONS

The present application is related to U.S. Provisional Patent Application No. 63/726,011, filed Nov. 27, 2024, titled UPDATING IT OPERATIONS MANAGEMENT PLATFORM DATA AT SCALE; U.S. Provisional Patent Application No. 63/734,423, filed Dec. 16, 2024, titled COMPUTER SYSTEM DATA INTEGRITY; U.S. Provisional Patent Application No. 63/791,108, filed Apr. 18, 2025 titled SYSTEM AND METHOD FOR MONITORING IT SERVICES AND PREVENTING DOWNSTREAM TICKET GENERATION IN IT SERVICE MANAGEMENT; U.S. Provisional Patent Application No. 63/823,028, filed Jun. 13, 2025, titled AUTOMATED DATA RETENTION CHECK; and U.S. Provisional Patent Application No. 63/847,920, filed Jul. 21, 2025, titled DEVICES, SYSTEMS, AND METHODS FOR THE DYNAMIC PROVISION OF CUSTOMER-SPECIFIC CONTENT; all of which are incorporated by reference herein in their respective entireties.

### BACKGROUND

Exporting large volumes of data is a complex process that comes with numerous challenges, both technical and operational. One of the primary concerns is maintaining data consistency. Distributed systems or systems with real-time updates often face difficulties ensuring that the exported data remains synchronized with the source. For example, changes made to the dataset during the export process can lead to partial or inconsistent exports, particularly if data snapshots are taken without freezing the source data. These inconsistencies can ripple through the system to downstream systems, which can create errors that are difficult to trace.

Data integrity is also at risk during large-scale exports. For example, errors such as incomplete records, missing fields, or schema mismatches can corrupt the data being exported. Without thorough validation checks, these issues may go undetected. Additionally, exporting large datasets places a heavy load on source systems and potentially disrupts their primary operations. For instance, running resource-intensive queries for export on a production database can degrade the performance that is experienced by end users and applications.

Managing the complexity of data exports becomes even more challenging when multiple destinations are involved. Each target system may have unique format or schema requirements, and coordinating consistent delivery across these systems requires careful planning. Moreover, the cost of exporting large datasets can quickly escalate, especially in cloud environments where data egress fees and storage costs add up. Such data storage expenses are further compounded by the need to reprocess data in the event of failures or errors, which are common in large-scale operations.

Troubleshooting and monitoring large data exports also poses difficulties. As the volume of data grows, logs and diagnostic tools can become unwieldy, making it harder to pinpoint issues such as slow queries, timeouts, or system bottlenecks. Error handling and recovery processes are equally complex. When an export fails, resuming it from a checkpoint requires sophisticated mechanisms to ensure continuity without duplication or data loss. Starting the process from scratch is often inefficient, especially with high data volumes.

Further, ensuring compatibility between the source and target systems is a persistent challenge. Different systems often use varying data formats, encodings, and protocols, requiring additional effort to harmonize data for seamless integration. Addressing these issues demands advanced tools, scalable architectures, and a robust framework of best practices to ensure data exports remain reliable, consistent, and efficient, even at scale.

### SUMMARY

In one general aspect, the present disclosure is directed to a robust computer system and related computer-implemented methods for managing and synchronizing large volumes of data, such as incident data for an enterprise’s Information Technology (IT) system, for example, from a dynamic source or sources into a persistent export table. The disclosure can be particularly well-suited for environments where the data are voluminous and continuously updated, potentially involving hundreds of thousands of records.

In various embodiments, assuming for the sake of example that the disclosed method is used for incident data, the process can begin with a data view, which can be a virtual table that serves as a master point of reference, or unified source of truth, across the organization. The data view consolidates data from multiple underlying data sources and tables. The data can be dynamic, and the data view can provide a comprehensive, real-time snapshot of all incidents in the system. The data view is the input for a job run or stored procedure, which is responsible for merging recent changes into an export table. The export table functions as a persistent, deduplicated repository, maintaining a unique record for each incident, identified by a compound, or composite, key. The compound key may be a fixed set of columns in the export table that together uniquely identify each incident.

During the merge process, each row in the data view is checked against the export table using the compound key. If a compound key from the data view does not exist in the export table, the system recognizes the entry as a new incident, prompting the creation of a new entry or record in the export table. If the compound key already exists in the export table and changes to the record are detected, the system updates the existing record in the export table. Additionally, the system may monitor for soft-deletes in the data view. Soft-deletes correspond to instances in which the incident is no longer considered to be active, but is retained in the data for reference. If an incident is marked as soft-deleted in the data view, the corresponding record in the export table can be updated to reflect this status. For example, the export table can be updated to set a predefined value to “0”, such as by setting the start date for the incident to “0” or using a similar marker in the export table indicative of a soft-delete status.

The export table not only serves as a repository but also tracks incidents that require downstream action. Any record that is new, updated, or soft-deleted is flagged for export. The flagged records can be exported to another system(s) to ensure that external systems receive only the necessary records and updates thereto, rather than the entire dataset.

In various aspects, an export table can be maintained for each downstream application (or grouping of downstream applications configured to receive the same export table). In various aspects of the present disclosure, an initial export table (e.g. table n) can be empty and, in such instances, upon initiating the job request, each import record can be copied into the initial export table as an export record. The complete snapshot of data in the data view can be duplicated in the initial export table and flagged for exporting, for example. In certain instances, upon exporting the flagged export records to the downstream application(s), the flags can be removed from the export table.

A copy of the export table can be stored between jobs; the stored export table can be used as a reference export table upon initiation of a follow-on job request to merge recent changes into a new export file. For example, upon initiation of another job request, the processing logic is repeated to merge the recent changes to the data view into the export table and flag the entries that are added, changed, and/or soft-deleted during the process, as further disclosed herein. Recent changes reflected in the updated export table (e.g. table n+1) can be inclusive of all changes in the data view since the creation of the previous version of the export table (e.g. table n) for each downstream application or grouping thereof. For example, upon rerunning the job, the initial, de-flagged export table (e.g. table n) can be provided to the server for merging updates based on the dynamic data in the data view to create the updated export table (e.g. table n+1).

The disclosed system provides several key benefits, especially in high-volume, continuously changing data environments. First, it can minimize redundant processing by focusing only on incremental changes (new, updated, or deleted records) in the data set, which is critical when dealing with hundreds of thousands of records (e.g. IT incidents). This efficiency reduces computational load and improves performance. The disclosed system can also ensure data consistency and accuracy because incorporation of the compound key guarantees that each record is uniquely identified and properly synchronized. Additionally, the present invention can enable efficient downstream consumption of the data by flagging only the necessary records for export, which can reduce the volume of data transmitted to external systems and ensure they remain up to date without being overwhelmed. Still further, the use of soft-deletes preserves historical context without physically deleting data, which may be required for auditability and/or compliance in large-scale incident management systems.

Together, these features create a scalable and resilient data synchronization process that is capable of supporting complex, high-volume incident management operations. These and other benefits that can be realized through embodiments of the present disclosure will be apparent from the description that follows.

### FIGURES

Various embodiments are described herein by way of example in conjunction with the following figures.

FIG. 1 is a diagram of a computer system, comprising a first computer system that collects and exports data in a table to a second, downstream computer system, according to various embodiments of the present invention.

FIG. 2 is a diagram of a process for exporting data in a table according to various embodiments of the present invention.

### DETAILED DESCRIPTION

Various embodiments of the present disclosure are directed to computer-implemented techniques for efficiently generating an export data table for consumption by a downstream system. In the description that follows, for sake of example, it is assumed that the data are “incident” data, although it should be recognized that the present disclosure is not necessarily so limited.

Incident data can refer to information and records related to unexpected events or disruptions that affect the normal functioning of an IT service, system, or infrastructure. Incidents typically include issues such as system outages, application failures, degraded performance, security breaches, or any other event that impacts the availability, functionality, or security of IT resources. Incident data is essential for identifying, analyzing, and resolving these issues.

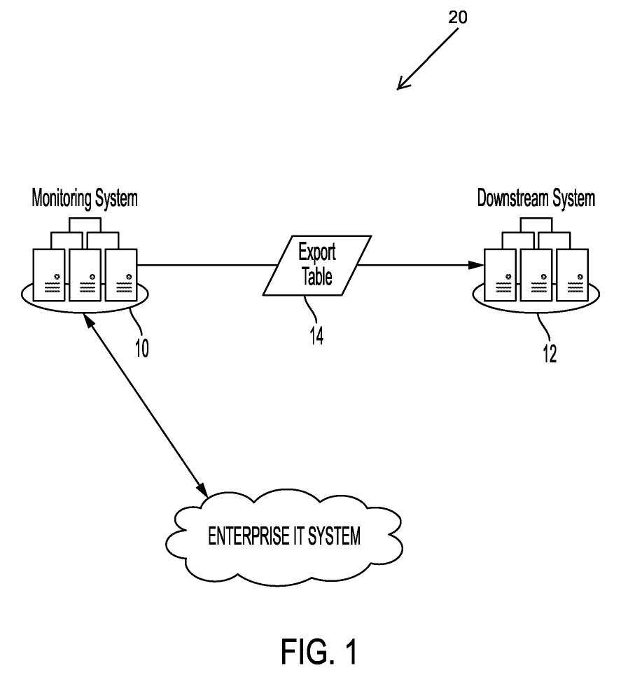

Referring to FIG. 1, a computer system 20 for use with an enterprise’s IT system is shown. In the example embodiment, incident data for the enterprise’s IT system is collected by a monitoring system 10. The monitoring system 10 may monitor, manage, and respond to IT infrastructure, applications, and security environments of the enterprise’s IT system. The monitoring system 10 can, for example: monitor the health and performance of IT systems and generate incident data when predefined thresholds are breached or anomalies are detected; track the performance and behavior of applications, identifying slow transactions, errors, or failures; track and manage incident tickets, providing structured workflows for incident resolution; oversee the hardware, virtual machines, containers, and cloud resources in an IT environment, identifying infrastructure-related issues; and/or centralize and analyze log files from various sources, helping to identify and correlate incidents. The monitoring system 10 may be, for example, an application performance monitoring (APM) tool that tracks performance and behavior of applications of the enterprise, identifying slow transactions, errors, or failures.

Monitoring systems are further disclosed in U.S. Patent Application No. 19/322,184, filed Sep. 8, 2025, titled CONFIGURING AN IT MONITORING SYSTEM and U.S. Patent Application No. 19/380,322, filed Nov. 4, 2025, titled COMPUTER SYSTEM DATA INTEGRITY, both of which are incorporated by reference herein in their respective entireties.

The incident data may be consumed by one or more downstream systems 12 of the enterprise that manage, analyze, and/or respond to IT disruptions, outages, security breaches, and/or any other incidents affecting the IT infrastructure. The downstream system(s) 12 can transform an export table 14 generated by the computer system 20 into actionable insights, automate response processes, and improve overall incident management efficiency. For example, a downstream incident management system can manage the lifecycle of incidents. As another example, a downstream security information and event management system can aggregate and analyze security-related data to detect, investigate, and respond to data threats. As a further example, a downstream IT service management system can manage and optimize IT services, including incident handling, change management, and problem management. These are examples of some downstream systems that could consume the export table; alternative downstream systems and functions are contemplated.

The downstream system 12 may include one or more computing systems executing software applications configured to receive and process exported data. Each downstream application can execute locally on a physical or virtual machine, or remotely in a cloud environment.

An electronic data network can connect the enterprise IT system, the monitoring system, the downstream applications, and other enterprise components disclosed herein. The electronic data network can use any suitable communication protocol supporting secure and reliable data transmission. In certain embodiments, an application programming interface (API) may be used to request, fetch, and transmit data throughout the system. The communication may employ RESTful API calls or gRPC-based remote procedure calls, which may be secured using Transport Layer Security (TLS) encryption. Alternatively, the components may exchange messages over an enterprise message bus or publish–subscribe infrastructure such as Kafka, RabbitMQ, or AWS SNS. These standardized communication protocols can enable the monitoring system 10 and the downstream system 12 to operate independently of the specific database implementation while ensuring end-to-end confidentiality and integrity of transmitted data.

Various embodiments of the present disclosure are directed to techniques for efficiently generating the export table 14, particularly when the system generating the data, e.g., the monitoring system 10, generates a large amount of data continuously, with numerous jobs collecting the data. And although embodiments of the present disclosure are described in the context of the monitoring system 10 collecting substantial amounts of incident data, it should be recognized that the present disclosure is not so limited and that the procedures for generating the export table 14 can be used for other types of data and/or can be used in instances is which the data is collected by other types of systems.

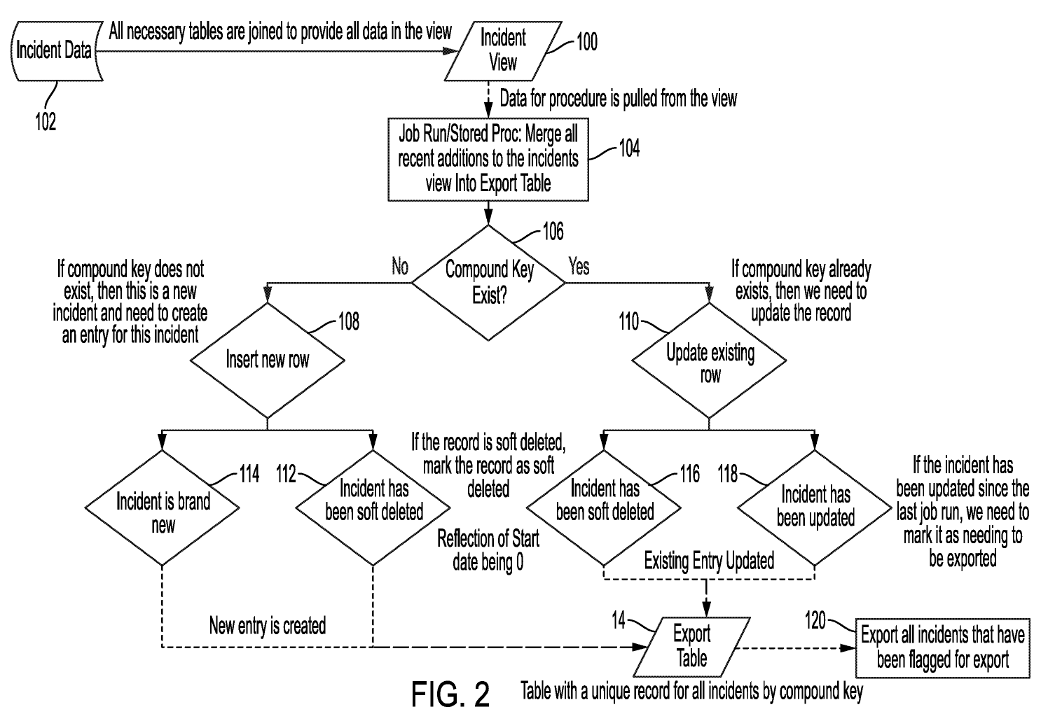

FIG. 2 is a diagram of a process flow of generating the export table 14 of FIG. 1 according to various embodiments of the present disclosure. The process illustrated in FIG. 2 is particularly suited for instances in which the export table 14 contains hundreds of thousands of rows of data, that are being updated continuously, and it is important for the downstream system(s) 12 to have accurate, up-to-date data.

The process depicted by FIG. 2 can be performed by a computer system or server of the enterprise, such as an on-premises computer system or a cloud computing system. The various servers and computer systems disclosed herein can include one or more processors, engines, control circuits, and/or memory units storing instructions to effect the logic processes further disclosed herein.

For example, the monitoring system 10 can perform the example process depicted in FIG. 2. The process, or aspects of, may be performed via, for example, a job run by the monitoring system 10 (or some other database system) or by one or more stored procedures. A stored procedure is a precompiled collection of structured query language (SQL) statements and logic (e.g., IF-statements, loops) that are stored in a database and can be executed as a single unit. The stored procedure(s) can be used in a relational database system such as SQL Server, Oracle, MySQL, or PostgreSQL, for example. A job may call stored procedures as part of performing the task.

In some embodiments, the monitoring application, the export logic, and the downstream application may execute on a single computing system or server. In such cases, inter-process or inter-service communication within the system can be used in place of network communication. For example, the monitoring application and downstream application may communicate via shared memory, inter-process communication (IPC), or a local message bus.

The process of FIG. 2 is an example in which the data are incident data, e.g., data related to IT incidents for an enterprise, however, the process of FIG. 2 could be used for other types of data. A data view 100 can be a dynamic virtual table that is created by aggregating all necessary data from a database 102, such as tables of incident data collected by the monitoring system 10 (FIG. 1). The data view 100 can be a virtual table of incident data that is the result of a SQL query or queries. The data view 100 preferably does not store data itself. Instead, the data view 100 dynamically pulls data from one or more underlying tables whenever the data view 100 is accessed.

Then, at step 104, a job or stored procedure, for example, merges all recent additions to the data view 100 into the export table 14. The export table 14 is a persistent table that holds the records that were previously processed or exported (or waiting to be exported). Each record/row in the table refers to a record, or incident, which is uniquely identified by a compound key. The compound key is a key made up of two or more columns of the export table whose values for the record in the export table 14 together uniquely identify the record in the export table 14.

The merging logic for the export table 14 is as follows. At step 106, the job/stored procedure looks to see if the compound key for each record of the data view 100 is present in the export table 14. If the compound key for a record from the data view 100 does not exist in the export table 14, the record has not been seen before. Therefore, at step 108, a new entry is created in the export table 14 for this newly-identified record (e.g. a new IT incident). On the other hand, if the compound key for a record already exists in the export table 14, the record is an existing record, in which case the existing record in the export table 14 is updated at step 110. To update the data, the values in the record/row for the record in the export table 14 can be updated with the values in the row for the record in the data view 100.

Going back to step 108, after adding the record to the export table 14, there can be a soft-deletion check. If the record is marked as soft-deleted in the data view 100 (e.g. the incident is resolved or otherwise completed), then the record can be, at step 112, marked as soft-deleted in the export table 14. In various embodiments, specifying a value of 0 in the “start date” column/attribute of the export table 14 can be a convention or flag that is used in the export table 14 to indicate that a record is soft-deleted, e.g., thereby indicating that the record is no longer active. On the other hand, if the new record/row at step 108 is not soft-deleted in the data view 100, it is determined to be a brand new record at step 114 and added to the export table 14.

A similar soft-deletion check can be performed in connection with updated existing rows at step 110. If the record is marked as soft-deleted in the view 100, then the record can be, at step 116, marked as soft-deleted in the export table 14, such as by specifying a value of 0 in predefined column or attribute in the export table 14. For example, the value of the “start date” cell in the export table 14 can be set to 0. Alternative attributes and/or values are contemplated. On the other hand, if the updated record/row at step 110 is not soft-deleted in the view 100, the record in the export table 14 is updated at step 118.

Finally, at step 120, the updated export table 14 can be exported to one or more downstream computer systems 12 or written to a designated output location so that the updated export table 14 can be accessed by the downstream computer system(s) 12. For example, the updated export table 14 can be written to a file (e.g., CSV, JSON, XML, or a proprietary format) and placed in a location accessible to the downstream system 12, such as a local storage (e.g., a file that is written to a local directory on the same server), to a network share (e.g., a file written to a shared drive accessible to other systems 12), or to cloud storage (e.g., a file uploaded to cloud storage). The export table 14 can also be exported by database-to-database synchronization, for example. That is, the records in the export table 14 can be inserted, updated, or deleted in a target database of the downstream system 12. For example, an application or stored procedure can connect to the target system and perform SQL operations to mirror the changes. Also, the source and target databases could be linked, allowing data to be transferred via queries. As yet another alternative, the updated export table 14 could be sent via HTTP requests to an API of the downstream system(s) 12. The API could be, for example, a REST API, where data is often formatted as JSON. The export file 14 could also be exported via message queues or streaming platforms that push the records of the export table 14 to a messaging system for asynchronous processing. Also, the export file 14 can be exported using an ETL (Extract, Transform, Load) tool(s), which automate the extraction of the flagged records of the updated export table 14, transform the data if needed, and load it into a target downstream system 12.

In some embodiments, each record in the export table 14 includes a flag field that indicates whether the record is pending export, has been exported, or requires deletion. When a record is newly added, updated, or soft-deleted, the corresponding flag can be set to indicate that the record should be exported during the next export cycle. After successful export to the downstream system 12, the flag can be cleared or reset to an unflagged state to prevent redundant transmission. Maintaining the flag field ensures that only incremental changes are transmitted and that exported data remains synchronized with minimal processing overhead.

As previously mentioned, the process of FIG. 2 can be implemented by a job and/or a stored procedure. A job is a scheduled or event-driven process that orchestrates the overall workflow. It controls the timing, sequence, and execution of tasks, including calling stored procedures and handling dependencies. The job can be run on a server, such as a server of the monitoring system 10 so that it runs directly on the same server that hosts the database 102. The job could also run on a separate application server (e.g., a server running general-purpose software outside the database 102), such as Python script running on a Linux or Windows server, a Java application on an application server, or an ETL tool running on a dedicated processing node. These jobs connect to the database 102 remotely over a network to execute queries or call stored procedures. The job could also be run in a cloud computing environment, leveraging serverless computing or container-based solutions. A cloud computing platform can trigger the job based on a schedule or event, and the job connects to the database in the cloud or on-premises.

These techniques can substantially reduce computational load and network bandwidth relative to full-table exports. Because only new, updated, or soft-deleted records are processed and transmitted, the system avoids redundant read–write operations, minimizes locking contention within the database, and improves overall throughput of the export process.

The stored procedure can be a precompiled database routine that encapsulates the merge logic to synchronize the export table 14 with the snapshot of the data view. It can be called by the job to handle the heavy lifting of data comparison, inserts, updates, and soft-deletes. It can be stored and executed within a database management system (DBMS) of the monitoring system 10. As such, the stored procedure can be part of the database itself under a specific schema, not a separate program or script file. The database platform for the monitoring system could comprise, for example, a SQL server, an Oracle database, a PostgreSQL database, or a MySQL server. The stored procedure can be executed by issuing a command to the database, such as automatically as part of a job.

The systems and methods described herein can be implemented using computing hardware executing software instructions. In various embodiments, one or more processors execute stored instructions to perform the described operations, with data and instructions held in memory such as RAM, flash storage, or other non-transitory computer-readable media. The functions may be carried out by software modules, database procedures, or services running on physical or virtual servers, including on-premises or cloud-based systems.

An electronic data network communicably couples the components described herein. The network may include any combination of local area networks (LANs), wide area networks (WANs), or cloud-based virtual networks using standard communication protocols such as TCP/IP over wired or wireless links. In some embodiments, network communication occurs via REST or gRPC interfaces, message queues, or secure data streams between applications executing on the same or different servers.

Equivalent implementations using any conventional computing architecture are contemplated. Unless otherwise specified, references to “servers,” “applications,” or “systems” encompass one or more computers programmed to perform the disclosed processes.

In one implementation, a computer-implemented method includes generating, by a server, a dynamic virtual table, where the dynamic virtual table is configured to aggregate data from a plurality of sources, where the dynamic virtual table may include a plurality of input records, where each input record may include a first compound key, and where each first compound key relies on data from a plurality of fields in the dynamic virtual table. The method further includes obtaining, by the server, an export table. The method also includes merging, by the server, at least one update from the dynamic virtual table into the export table, where merging at least one update into the export table may include, for each first compound key in the dynamic virtual table: scanning the export table for a matching compound key. The method further includes updating the export table based on the scan, where updating the export table may include either: adding an export record to the export table based on the scan not identifying a match for the first compound key; or updating at least one data field in an export record in the export table based on the scan (a) identifying the matching compound key in the export table and (b) determining a difference between the input record in the dynamic virtual table and the export record in the export table with the matching compound key. The method also includes exporting, by the server, data from the export table to a downstream application.

Implementations of the method may include one or more of the following features. The computer-implemented method may include receiving, by the server, a request to update the export table. The server may include an SQL server, where the export table may include an SQL table, and where the SQL table is stored after exporting data to the downstream application. The method may include transmitting an Application Programming Interface (API) call from the server to an enterprise application, where the API call requests access to data from the enterprise application for the dynamic virtual table. The plurality of sources may include information technology (IT) incident data tables, and where the method further may include fetching it incident data from a monitored it system. The IT incident data may include records of unexpected events or disruptions identified in the monitored it system, and where the method further may include receiving, by the server, a start time for each unexpected event or disruption. Adding an export record to the export table may include adding a new row to the export table. The first compound keys may include data from a plurality of columns in the dynamic virtual table, and where each first compound key uniquely corresponds to a single export record in the export table. Updating the export table based on the scan further may include performing a soft-delete check. The computer-implemented method may include receiving a job request to scan the dynamic virtual table for new, updated, and soft-deleted records. Performing the soft-delete check may include identifying an import record marked as soft-deleted in the dynamic virtual table and updating a soft-check data field for the export record in the export table. Updating the soft-check data field in the export table may include setting a start time value for the export record to zero (0). The computer-implemented method may include flagging at least one export record in the export table and exporting all flagged export records in the export table to the downstream application. The export table may include a persistent table, and the method further may include unflagging all exported export records in the export table and storing the export table.

In another implementation, a system for exporting updated records includes a monitoring application executing on one or more computing systems; a downstream application executing on the one or more computing systems; a server including a processor and a memory; and an electronic data network communicably coupling the server to the monitoring application and the downstream application. The memory stores instructions executable by the processor to: retrieve data from the monitoring application via the electronic data network and generate a virtual table aggregating the retrieved data, where the virtual table includes a plurality of input records, where each input record includes a first compound key, and where each first compound key relies on data from a plurality of fields in the virtual table. Further, the processor is to retrieve an export table; for each first compound key in the virtual table, scan the export table for a matching compound key; and, based on the scan, either (a) add an export record to the export table or (b) update at least one data field in an export record in the export table; and export data from the export table to the downstream application via the electronic data network.

Implementations of the system may include one or more of the following features. The virtual table may include a real-time snapshot of dynamic data received from a plurality of sources, and the export table may include a persistent, deduplicated depository of tabular data corresponding to information technology (it) incident data. Each first compound key may rely on data from a plurality of columns in the virtual table, and each first compound key uniquely corresponds to a single export record in the export table. The export table may include a plurality of rows and a plurality of columns, where each row may include a single export record, and where the plurality of columns may include a soft-delete column and a flag column. The soft-delete column may include a zero (0) value for export records identified as soft-deleted in the virtual table. The flag column may include a true value for each new, updated, or soft-deleted export record, and where the flag column is settable to a false value by the processor upon exporting the export record to the downstream application.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

In addition, features described in connection with one embodiment may be combined with features of other embodiments, even if not explicitly shown or described, unless otherwise noted as mutually exclusive. Accordingly, the scope of the present invention should be construed broadly, consistent with the appended claims and their legal equivalents, rather than limited to the specific examples described.

What is claimed is:

1. A computer-implemented method, comprising:
generating, by a server, a dynamic virtual table, wherein the dynamic virtual table is configured to aggregate data from a plurality of sources, wherein the dynamic virtual table comprises a plurality of input records, wherein each input record comprises a first compound key, and wherein each first compound key relies on data from a plurality of fields in the dynamic virtual table;
obtaining, by the server, an export table;
merging, by the server, at least one update from the dynamic virtual table into the export table, wherein merging at least one update into the export table comprises, for each first compound key in the dynamic virtual table:
scanning the export table for a matching compound key; and
updating the export table based on the scan, wherein updating the export table comprises either:
adding an export record to the export table based on the scan not identifying a match for the first compound key; or
updating at least one data field in an export record in the export table based on the scan (a) identifying the matching compound key in the export table and (b) determining a difference between the input record in the dynamic virtual table and the export record in the export table with the matching compound key; and
exporting, by the server, data from the export table to a downstream application.

2. The computer-implemented method of claim 1, further comprising receiving, by the server, a request to update the export table.

3. The computer-implemented method of claim 2, wherein the server comprises an SQL server, wherein the export table comprises an SQL table, and wherein the SQL table is stored after exporting data to the downstream application.

4. The computer-implemented method of claim 1, further comprising transmitting an Application Programming Interface (API) call from the server to an enterprise application, wherein the API call requests access to data from the enterprise application for the dynamic virtual table.

5. The computer-implemented method of claim 1, wherein the plurality of sources comprises information technology (IT) incident data tables, and wherein the method further comprises fetching IT incident data from a monitored IT system.

6. The computer-implemented method of claim 5, wherein the IT incident data comprises records of unexpected events or disruptions identified in the monitored IT system, and wherein the method further comprises receiving, by the server, a start time for each unexpected event or disruption.

7. The computer-implemented method of claim 1, wherein adding an export record to the export table comprises adding a new row to the export table.

8. The computer-implemented method of claim 1, wherein the first compound keys comprise data from a plurality of columns in the dynamic virtual table, and wherein each first compound key uniquely corresponds to a single export record in the export table.

9. The computer-implemented method of claim 1, wherein updating the export table based on the scan further comprises performing a soft-delete check.

10. The computer-implemented method of claim 9, further comprising receiving a job request to scan the dynamic virtual table for new, updated, and soft-deleted records.

11. The computer-implemented method of claim 9, wherein performing the soft-delete check comprises identifying an import record marked as soft-deleted in the dynamic virtual table and updating a soft-check data field for the export record in the export table.

12. The computer-implemented method of claim 11, wherein updating the soft-check data field in the export table comprises setting a start time value for the export record to zero (0).

13. The computer-implemented method of claim 1, further comprising:
flagging at least one export record in the export table; and
exporting all flagged export records in the export table to the downstream application.

14. The computer-implemented method of claim 1, wherein the export table comprises a persistent table, and wherein the method further comprises:
unflagging all exported export records in the export table; and
storing the export table.

15. A system for exporting updated records, wherein the system comprises:
a monitoring application executing on one or more computing systems;
a downstream application executing on the one or more computing systems;
a server comprising a processor and a memory; and
an electronic data network communicably coupling the server to the monitoring application and the downstream application;
wherein the memory stores instructions executable by the processor to:
retrieve data from the monitoring application via the electronic data network;
generate a virtual table aggregating the retrieved data, wherein the virtual table comprises a plurality of input records, wherein each input record comprises a first compound key, and wherein each first compound key relies on data from a plurality of fields in the virtual table;
retrieve an export table; and
for each first compound key in the virtual table, scan the export table for a matching compound key and, based on the scan, either (a) add an export record to the export table or (b) update at least one data field in an export record in the export table; and
export data from the export table to the downstream application via the electronic data network.

16. The system of claim 15, wherein the virtual table comprises a real-time snapshot of dynamic data received from a plurality of sources, and wherein the export table comprises a persistent, deduplicated depository of tabular data corresponding to information technology (IT) incident data.

17. The system of claim 15, wherein each first compound key relies on data from a plurality of columns in the virtual table, and wherein each first compound key uniquely corresponds to a single export record in the export table.

18. The system of claim 17, wherein the export table comprises a plurality of rows and a plurality of columns, wherein each row comprises a single export record, and wherein the plurality of columns comprises a soft-delete column and a flag column.

19. The system of claim 18, wherein the soft-delete column comprises a zero (0) value for export records identified as soft-deleted in the virtual table.

20. The system of claim 18, wherein the flag column comprises a true value for each new, updated, or soft-deleted export record, and wherein the flag column is settable to a false value by the processor upon exporting the export record to the downstream application.
